(19) United States
(12) Patent Application Publication
(10) Pub. No.: US 2007/0111036 A1
(43) Pub. Date: May 17, 2007

(54) Substrate for magnetic recording medium and fabrication method thereof

(76) Inventors: Masaru Ito, Tokyo (JP); Ken Ohashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/598,706

(22) Filed: Nov. 14, 2006

(30) Foreign Application Priority Data
Nov. 16, 2005 (JP) 2005-331568

(51) Int. Cl. G11B 5/66; G11B 5/706

(52) U.S. Cl. 428/829; 428/846.9; 428/831.1; 427/127; 427/437; 427/443.1; 427/430.1

(57) ABSTRACT

Heat treatment is performed on a plated soft magnetic film, so that liquid components and gaseous components having been taken in the film during a plating step are eliminated. The temperature of the heat treatment is preferably set at 100° C. to 350° C. The heat treatment is effective when being divided into at least two times of heat treatment: a first heat treatment performed before a polishing step and a second heat treatment performed after the polishing step.

### BACKGROUND OF THE INVENTION

1. Field of the Invention

The present invention relates to a substrate for a magnetic recording medium, a fabrication method thereof, and the magnetic recording medium, and more specifically relates to a substrate suitable for the fabrication of a perpendicular magnetic recording medium having excellent signal reproduction characteristics with low noise and a fabrication method thereof.

2. Description of the Related Art

In the technical field of information recording, hard disk drives acting as means for magnetically reading/writing information including characters, images, or music have become necessary as primary external recorders and internal recording means of electronic equipment such as personal computers. Such hard disk drives include hard disks serving as magnetic recording media. For conventional hard disks, a so-called “in-plane magnetic recording method (longitudinal magnetic recording method)” has been used in which magnetic information is longitudinally written on a surface of a disk.

FIG. 1 is a sectional view schematically showing a typical multilayer structure of a hard disk of the longitudinal magnetic recording method. A Cr base layer 2 formed by sputtering, a magnetic recording layer 3, and a carbon layer 4 serving as a protective film are sequentially stacked on a non-magnetic substrate 1, and a liquid lubricating layer formed by applying a liquid lubricant is formed on a surface of the carbon layer 4 (for example, Japanese Patent Laid-Open No. 5-143972). The magnetic recording layer 3 is made of a Co alloy having uniaxial crystal magnetic anisotropy. The Co alloy includes CoNiCr, CoCrTa, CoCrPt alloys and the like. The crystal grains of the Co alloy are horizontally magnetized on a surface of the disk, so that information is recorded.

However, in the longitudinal magnetic recording method, when individual recording bits are reduced in size to increase a recording density, the north poles and south poles of the adjacent recording bits repel each other and make a boundary area magnetically indistinct. Thus for a high recording density, it is necessary to reduce the thickness of the magnetic recording layer and the size of crystal grains. It has been pointed out that finer crystal grains (smaller volumes) and smaller recording bits cause a phenomenon called “thermal fluctuation” in which the magnetization direction of the crystal grains is disturbed by thermal energy and data is deleted, and thus a high recording density has been regarded as being limited. In other words, when a KuV/k_{B}T ratio is small, the influence of the thermal fluctuation is serious where Ku represents the magnetocrystalline anisotropy energy of the recording layer, V represents the volume of the recording bit, K_{B} represents a Boltzmann constant, and T represents an absolute temperature (K).

In consideration of these problems, a “perpendicular magnetic recording method” has been studied. In this recording method, a magnetic recording layer is magnetized perpendicularly to a surface of a disk. Thus the north poles and the south poles are alternately combined and placed in a bit arrangement and the north poles and south poles of magnetic domains are adjacent to each other and increase magnetization, so that a state of magnetization (magnetic recording) is more stabilized. In other words, when the magnetization direction is recorded in the perpendicular direction, the demagnetizing fields of recording bits are reduced. Thus as compared with the longitudinal magnetic recording method, it is not so necessary to reduce the thickness of the recording layer. For this reason, a recording layer can be increased in thickness to increase the crystal grains in size in the vertical direction, so that the overall KuV/k_{B}T ratio increases and can reduce the influence of “thermal fluctuation”.

As described above, in the perpendicular magnetic recording method, demagnetizing fields can be reduced and a KᵤV value can be obtained, unstableness of magnetization due to “thermal fluctuation” can be reduced and the limit of a recording density can be greatly expanded. Thus the perpendicular magnetic recording method is expected as a method for achieving super high density recording.

FIG. 2 is a sectional view schematically showing a basic layered structure of a hard disk acting as a “perpendicular two-layer magnetic recording medium” in which a recording layer for perpendicular magnetic recording is provided on a soft magnetic backing layer. A soft magnetic backing layer 12, a magnetic recording layer 13, a protective layer 14, and a lubricating layer 15 are sequentially stacked on a non-magnetic substrate 11. In this structure, permalloy and CoZrTa amorphous are typically used for the soft magnetic backing layer 12. Further, for the magnetic recording layer 13, a CoCr alloy, a multilayer film in which several layers of a PtCo layer and an ultrathin film of Pd and Co are alternately stacked, or a SmCo amorphous film or the like is used.

As shown in FIG. 2, in the hard disk of the perpendicular magnetic recording method, the soft magnetic backing layer 12 is provided as the base of the magnetic recording layer 13. The soft magnetic backing layer 12 has a magnetic property of “soft magnetism” and has a thickness of about 100 nm to 200 nm. The soft magnetic backing layer 12 is provided to increase a writing magnetic field and reduce the demagnetizing field of the magnetic recording film. Further, the soft magnetic backing layer 12 acts as a path of a magnetic flux from the magnetic recording layer 13 and a path of a writing magnetic flux from a recording head. In other words, the soft magnetic backing layer 12 plays the same role as an iron yoke provided in a permanent magnet magnetic circuit. Thus in order to avoid magnetic saturation during writing, the thickness of the soft magnetic backing layer 12 has to be set larger than that of the magnetic recording layer 13.

In view of the multilayer configuration, the soft magnetic backing layer 12 corresponds to the Cr base layer 2 provided in the hard disk of the longitudinal magnetic recording method. However, the soft magnetic backing layer 12 is not formed as easily as the Cr base layer 2 of the longitudinal recording medium.

In the hard disk of the longitudinal magnetic recording method, each layer is not more than 20 nm in thickness and is formed by a dry process (mainly by magnetron sputtering, see Japanese Patent Laid-Open No. 5-143972). Also for perpendicular two-layer recording media, various methods have been studied to form the magnetic recording layer 13 and the soft magnetic backing layer 12 by the dry process. When the soft magnetic backing layer 12 is formed by the dry process, a sputtering target has to be a ferromagnetic material having strong saturation magnetization and the soft magnetic backing layer 12 has to be 100 nm or larger in thickness. For these reasons, perpendicular two-layer recording media have serious problems about mass production and productivity in consideration of the evenness of the film thickness and composition, the life of the target, the stability of the process, and the low deposition rate above all.

Further, for a higher recording density, it is necessary to minimize the flying height of a magnetic head which floats above a surface of a magnetic disk. However, a relatively thick film formed by the dry process is apt to have low surface smoothness and causes head crash.

For this reason, attempts have been made to form the soft magnetic backing layer 12 by a plating method which can easily increase the film thickness and enable polishing (for example, Japanese Patent Laid-Open No. 2005-108407).

When the soft magnetic layer is formed by the plating method, a number of magnetic domains appear which are magnetized in a specific direction over a range of several millimeters to several centimeters on a surface of a plating film making up the soft magnetic layer, and domain walls appear on the interfaces of the magnetic domains. When the soft magnetic layer having such domain walls is used as a backing layer in a hard disk for a perpendicular two-layer magnetic recording medium, a leakage magnetic field generated from the domain walls causes isolated pulse noise called spike noise or micro-spike noise, so that the signal reproduction property may be seriously deteriorated.

Thus, in order to achieve a perpendicular two-layer magnetic recording medium having excellent characteristics with a simple method, the present inventors have devoted themselves to study conditions for forming a soft magnetic film by the plating method and kinds of applicable soft magnetic film, and the inventors have found that by using a soft magnetic film as a backing layer, the occurrence of domain walls is reduced in the soft magnetic film and spike noise is effectively reduced. The soft magnetic film is formed of an alloy of two or more metals selected from the group consisting of Co, Ni and Fe by an electroless plating method on a substrate which forms a magnetic recording medium, and the soft magnetic film has anisotropy in the in-plane circumferential direction of the substrate (Japanese Patent Laid-Open No. 2005-108407).

In this case, anisotropy means a difference (δH=Hd−Hc) between a magnetization saturation magnetic field strength (Hd) in the in-plane radial direction and a magnetization saturation magnetic field strength (Hc) in the in-plane circumferential direction. When δH is positive (Hd−Hc>0), the in-plane radial direction is the easy axis of magnetization. When δH is negative (Hd−Hc<0), the in-plane circumferential direction is the easy axis of magnetization.

However, also in a perpendicular magnetic recording medium including, as a backing layer, the soft magnetic film described in Japanese Patent Laid-Open No. 2005-108407, spike noise is not reduced to a level presenting no problems in the practical use of the perpendicular magnetic recording medium having a high recording density.

### SUMMARY OF THE INVENTION

The present inventors have further studied the source of spike noise. As a result, the inventors have found that one cause of noise is liquid components and components in gas. These components are derived from a plating wet process. When a soft magnetic backing layer for a perpendicular two-layer magnetic recording medium is formed by a plating method, various components (including an impurity, a gas component, a liquid component) derived from the wet plating process are taken into the soft magnetic backing layer. The inventors have found that substantially excellent soft magnetic properties can be obtained, as the magnetic properties of the soft magnetic film, by impurities including B, P, C ands derived from a reducing agent or the like having been added into a plating bath, whereas gas components and liquid components taken into the soft magnetic backing layer cause noise of the magnetic recording medium.

An object of the present invention is to provide a substrate for a perpendicular magnetic recording medium which reduces noise generating components contained in a soft magnetic backing layer formed by plating, and provide a perpendicular magnetic recording medium which reduces noise of a magnetic recording layer formed on the soft magnetic backing layer and has excellent signal generation characteristics.

A substrate for a magnetic recording medium according to the present invention comprises a non-magnetic substrate shaped like a disk having a diameter of 90 mm or less and a soft magnetic backing layer provided on a major surface of the substrate, wherein the soft magnetic backing layer is a plating layer containing at least two elements selected from the group consisting of Co, Ni, and Fe and at least one element selected from the group consisting of B, C, P and S, and the plating layer has at least two histories of heat treatment after plating deposition.

It is preferable that the plating layer is 150 nm to 1000 nm in thickness and a temperature of the heat treatment is 100° C. to 350° C.

Further, it is preferable that the non-magnetic substrate is a silicon wafer, and provided with a base plating layer made of Ni or NiP between the major surface of the substrate and the plating layer, and the base plating layer is 10 nm to 1000 nm in thickness.

Moreover, it is preferable that the soft magnetic backing layer has a surface roughness expressed by a Ra (Arithmetical Mean Deviation of the Roughness) value of 0.4 nm or less.

A method of fabricating a substrate for a magnetic recording medium according to the present invention comprises: an electroless plating step of forming a soft magnetic backing layer on a major surface of a non-magnetic substrate shaped like a disk having a diameter of 90 mm or less, and a heat treatment step after the electroless plating step, wherein in the electroless plating step, plating deposition of the soft magnetic backing layer is performed by dipping the substrate into a plating bath containing at least two metal ions selected from the group consisting of Co, Ni, and Fe and at least one element selected from the group consisting of B, C, P and S, and the heat treatment step is performed at 100° C. to 350° C.

It is preferable that the heat treatment step is performed at 150° C. to 300° C.

Further, it is preferable that the method comprises a polishing step after the plating deposition of the soft magnetic backing layer and the heat treatment step includes a first heat treatment step performed before the polishing step and a second heat treatment step performed after the polishing step.

Moreover, it is preferable that a treatment temperature of the second heat treatment step is higher than a treatment temperature of the first heat treatment step by 30° C. or more. It is more preferable that at least one of the first and second heat treatment steps is performed while a magnetic field of 100 Oe to 5 kOe is applied.

It is preferable that the heat treatment step is performed in an atmosphere of cleaned air or inert gas or in a vacuum.

Furthermore, it is preferable that a silicon wafer is selected as the substrate, and the method comprises, before the electroless plating step, a step of forming a base plating layer made of Ni or NiP by dipping the silicon wafer into a plating bath containing a Ni ion or a plating bath obtained by adding a phosphorus reducing agent to a bath containing a Ni ion. It is more preferable that the method comprises, before the step of forming the base plating layer, a substrate surface processing step of removing an oxide film on a surface of the silicon wafer.

A magnetic recording medium of the present invention comprises a magnetic recording layer on the soft magnetic backing layer provided in the substrate for a magnetic recording medium of the present invention.

The soft magnetic backing layer provided in the substrate for a magnetic recording medium of the present invention considerably reduces the content of liquid components and gaseous components derived from a plating wet process. It is thus possible to reduce the occurrence of domain walls, reduce spike noise from the magnetic recording layer, and achieve a magnetic recording medium having a high recording density with an excellent writing property because of an increase in the magnetic fluxes of a head.

Further, in the substrate for a magnetic recording medium of the present invention, the soft magnetic backing layer is formed by wet electroless plating. It is thus possible to remarkably simplify the fabrication process as compared with the formation by a dry process such as vapor deposition and achieve high productivity.

The thickness and surface flatness of the soft magnetic backing layer can be controlled by polishing the soft magnetic backing layer after plating deposition. Thus the present invention is suitable for fabricating a magnetic recording medium having an excellent head floating property.

### BRIEF DESCRIPTION OF THE DRAWINGS

FIG. 1 is a sectional view schematically showing a typical multilayer structure of a hard disk of a longitudinal magnetic recording method;

FIG. 2 is a sectional view schematically showing a basic layered structure of a perpendicular two-layer magnetic recording medium in which a recording layer for perpendicular magnetic recording is provided on a soft magnetic backing layer;

FIG. 3 is a sectional view schematically showing a basic layered structure of the perpendicular two-layer magnetic recording medium of the present invention in which a Si substrate is used as a non-magnetic substrate and a base plating layer (nucleation film) is provided;

FIG. 4 is a flowchart for explaining an example of the fabrication process of a substrate for a magnetic recording medium when a first heat treatment step is provided after plating deposition and a second heat treatment step is provided after the polishing step of a soft magnetic film; and

FIG. 5 is a conceptual rendering for explaining a state of plating deposition of the soft magnetic film.

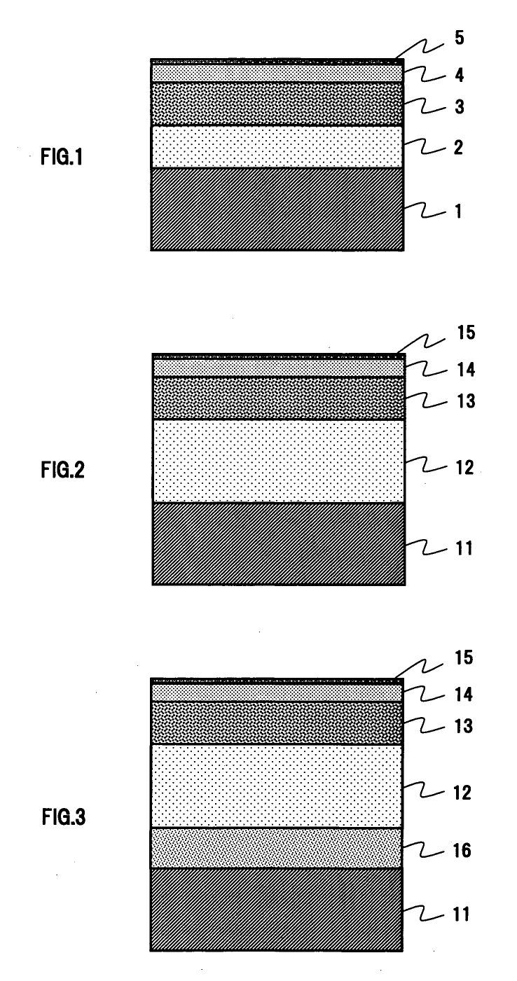

### DETAILED DESCRIPTION OF THE INVENTION

An embodiment for implementing the present invention will be specifically described below with reference to the accompanying drawings.

A substrate for a magnetic recording medium of the present invention is provided for perpendicular magnetic recording. A hard disk serving as a perpendicular two-layer magnetic recording medium can be obtained by forming a magnetic recording layer on a soft magnetic backing layer. To be specific, in the substrate for the magnetic recording medium of the present invention, as shown in FIG. 2, a soft magnetic backing layer 12 formed by electrolytic plating is provided on a non-magnetic substrate 11. Further, a magnetic recording layer 13 for perpendicular magnetic recording is formed on the soft magnetic backing layer 12 and a protective layer 14 and a lubricating layer 15 are sequentially stacked thereon, so that the magnetic recording medium of the present invention is obtained. As shown in FIG. 3, when using a Si substrate as the non-magnetic substrate 11, a base plating layer (nucleation film) 16 made of Ni or NiP is provided between the non-magnetic substrate 11 and the soft magnetic backing layer 12.

The configurations of the layers will be described in order.

(The Configurations of the Layers)

(non-magnetic substrate 11): A non-magnetic substrate used for the substrate for the magnetic recording medium of the present invention may be a substrate or a glass substrate which is formed by performing Ni—P electroless plating on an aluminum substrate which has been conventionally used for fabricating a magnetic recording medium. Further, the non-magnetic substrate may be a Si substrate. When using a glass substrate, it is necessary to apply a conductive film beforehand by a sputtering method and so on.

The Si substrate does not always have to be a single-crystal substrate. However, a single-crystal Si substrate has the following advantage: an in-plane atomic arrangement is even on a surface of the substrate, and an in-plane surface chemical state and an in-plane surface potential state are uniform in a plating step. In other words, the single-crystal Si substrate used as the non-magnetic substrate 11 has the following advantage: direct displacement plating can be performed on the single-crystal Si substrate 11 during the formation of the base plating layer (nucleation film, will be described later) 16 made of Ni or NiP, and magnetic unevenness caused by uneven plating can be reduced. In the following explanation, the non-magnetic substrate 11 is a single-crystal Si substrate.

A single-crystal Si substrate formed by crystal breeding according to CZ (Czochralski) method or FZ (floating zone) method is readily available. The plane direction of the substrate is not particularly limited and thus any plane direction including (100), (110) or (111) may be used. Further, the substrate may contain, as an impurity, a donor or an acceptor with an atomic ratio of about 10% (to 10²² atoms/cm³) relative to Si, or a light element including oxygen, carbon, and nitrogen.

In the present invention, the substrate is 90 nm or less in diameter regardless of whether the non-magnetic substrate 11 is a single-crystal Si substrate or not. This is because this diameter forms a uniform flow of a plating solution on the surface of the substrate in the step of electrolytic plating deposition of the soft magnetic backing layer 12 (described later). This point will be described later.

(Surface treatment of the Si substrate): As described above, when using the Si substrate as the non-magnetic substrate 11 of the present invention, the base plating layer 16 is provided between the Si substrate 11 and the soft magnetic backing layer 12. Thus, before the formation of the base plating layer 16, the surface of the Si substrate 11 is activated. The surface activation facilitates the subsequent displacement plating of the base plating layer, increasing the adhesion of the film.

In the surface activation, an oxide film having been naturally formed on the surface of the Si substrate 11 is mainly removed. In this process, Si atoms on the extreme surface of the Si substrate 11 are etched and the surface of the substrate is chemically activated.

The etching can be performed by various methods such as acid treatment, alkali treatment, or electrolysis. For example, in the case of etching using an alkaline solution including caustic soda, a solution containing a 2 to 60 weight percent concentration of alkali is set at 30° C. to 100° C., the surface oxide film of the Si substrate is removed, and the surface of the Si substrate is slightly corroded.

(Base plating layer 16): The base plating layer 16 is formed by performing displacement plating of Ni or NiP on the surface of the Si substrate having been subjected to the surface activation. When the base plating layer 16 is a Ni layer, a plating solution containing Ni ions of 0.01 N or more, preferably Ni ions of 0.05 N to 0.3 N as elements is used. The Si substrate 11 is dipped into the plating solution and plating deposition is performed thereon. When the base plating layer 16 is a NiP layer, a phosphorus (P) reducing agent is added to the plating solution to perform plating deposition. The surfaces of the Ni layer and NiP layer obtained thus may be modified by a Cu film, a Pd film, or an Au film.

The base plating layer 16 is preferably 10 nm to 1000 nm in thickness and more preferably 50 nm to 700 nm in thickness. This is because the base plating layer 16 having a thickness smaller than 10 nm is apt to cause uneven polycrystalline grain size of a metal (alloy) in the subsequent plating step of the soft magnetic backing layer 12 and the base plating layer 16 having a thickness larger than 1000 nm increases the crystal grain size.

(Soft magnetic backing layer 12): The soft magnetic backing layer 12 is formed by an ordinary method known as electroless plating, and then the plating film is polished to a predetermined thickness of 150 nm to 1000 nm.

The thickness range is set for the following reason: when the soft magnetic backing layer 12 is larger than 1000 nm in thickness, it is difficult to eliminate liquid components and gaseous components which have been taken into the film during heat treatment (described later) and magnetic noise generated from the soft magnetic backing layer 12 increases during the signal reproduction of the hard disk, so that the S/N characteristics of the recording medium easily become worse. When the soft magnetic backing layer 12 is less than 150 nm in thickness, soft magnetic properties are susceptible to the influence of the base plating layer 16 and the magnetic recording layer 13 has an insufficient magnetic transmission property as a base, so that the overwrite property of the recording medium deteriorates.

Any one of a sulfide bath and a chloride bath can be used as an electroless plating bath. Various kinds of metal may be contained in the bath. Since the plating film has to have the magnetic property of a soft magnetic film and simultaneously the crystal structure has to be a cubic crystal, a plating bath containing a metallic salt including at least two elements selected from the group consisting of Co, Ni, and Fe is selected. These metallic elements are selected because an excellent soft magnetic property is hard to obtain in a plating film of a single element, though electroless plating can be performed on all of Co, Ni and Fe. A specific bath composition is, for example, a mixed bath of nickel sulfate and cobalt sulfate or a mixed bath containing iron sulfate. A preferable concentration of the bath is 0.01 N to 0.5 N. The temperature of the plating bath is preferably set at 40° C. to 100° C.

Further, a reducing agent corresponding to a metal ion contained in the bath is added to the plating bath when necessary such that at least one element selected from the group consisting of B, C, P and S is intentionally contained in the plating film. Such a reducing agent includes, for example, hypophosphorous acid (H₂PO₂) and dimethylamine borane (DMAB:(CH₃)₂HNBH₃). In consideration of the soft magnetic property of the film, at least one element of B, C, P and S is contained in the plating film. The plating film advantageously containing at least one of these elements is a major point of difference from a dry deposition method such as the sputtering method.

The way the plating solution flows near the surface of the substrate in the electroless plating step affects the magnetic anisotropy of the obtained soft magnetic plating film. Further, when the diameter of the plated substrate exceeds 90 mm, it is difficult to form an even flow of the plating solution on the surface of the substrate. Therefore, it is preferable to adjust a liquid flow in the plating bath by adjusting a liquid circulation during plating deposition, stirring the plating solution with a stirring bar such as a paddle, or causing the plated substrate to revolve or rotate on its axis. Of these methods, the method of causing the plated substrate to revolve or rotate on its axis in the bath is a simple and effective method for obtaining a proper flow velocity. Therefore, a liquid flow in the plating bath is adjusted by properly combining the revolution and rotation of the plated substrate in the bath and the circulation and stirring of the plating solution. According to the experimental results of the present inventors, the velocity of revolution and rotation is preferably set at 10 rpm to 100 rpm and more preferably set at 20 rpm to 80 rpm.

(Polishing of the soft magnetic film): In the polishing step after the plating deposition of the soft magnetic film, double sided buffing is performed using inorganic particulates of colloidal silica, ceria, and so on and surface roughness is controlled concurrently with the adjustment of the thickness on the front and back sides of the soft magnetic film. This step is basically similar to polishing of a Si single crystal wafer. The thickness is adjusted on the both sides while polishing damage to the soft magnetic film is minimized, so that clean polishing is performed with high surface smoothness. In view of the securing of low floating of a magnetic head, the smoother surface of the soft magnetic film after polishing, the better. However, in consideration of the floating stability of the head, a Ra (Arithmetical Mean Deviation of the Roughness) value of 0.4 nm or less is enough. When the Ra value exceeds 0.4 nm, the magnetic head is hard to float low (10 nm or lower).

(Heat treatment of the soft magnetic film): In the present invention, heat treatment is performed on the soft magnetic film having been formed by plating, so that liquid components and gaseous components having been taken into the film in the plating step are eliminated to reduce a concentration of the components in the film. Such elimination of components improves resistance to corrosion as well as the magnetic properties of the soft magnetic film.

When the heat treatment temperature is too high, the crystal grain size of the soft magnetic film increases (the average size is assumed to be 5 nm to 8 nm) and the magnetic properties deteriorate (for example, a coercive force Hc increases). Thus the heat treatment temperature is preferably set at 350° C. or lower. Further, the elimination of liquid components and remaining gas is assumed to require a temperature of about 100° C. Liquid components (for example, water or a plating solution) are not always captured into a hole or a flaw in a simple manner but may be captured as water of crystallization. Thus the temperature is preferably set at 100° C. or higher and more preferably at 150° C. to 300° C.

The number of times and temperature of the heat treatment are properly selected according to the thickness, composition and soon of the formed soft magnetic film. The heat treatment is effective when being divided into at least two times of heat treatment including a first heat treatment performed before the polishing step and a second heat treatment performed after the polishing step. In this case, it is preferable to perform at least one of the first and second heat treatment steps while a magnetic field of 100 Oe to 5 kOe is applied.

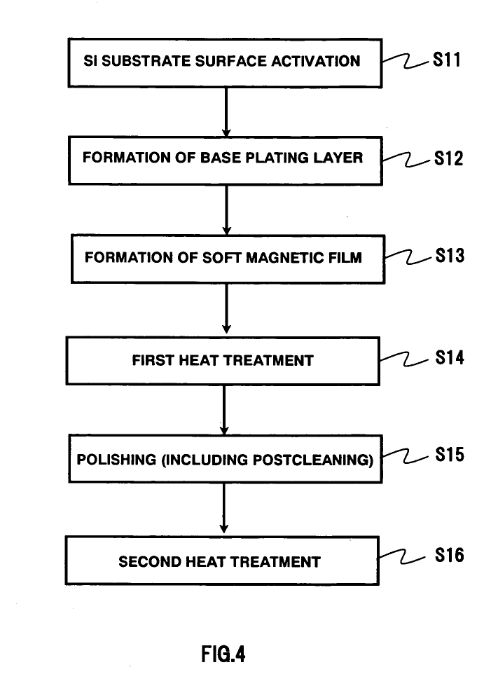

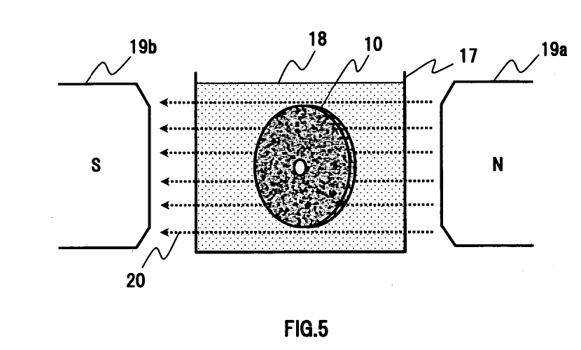

FIG. 4 is a flowchart for explaining an example of the fabrication process of the substrate for the magnetic recording medium when a first heat treatment step is provided after the plating deposition and a second heat treatment step is provided after the polishing step of the soft magnetic film. A single-crystal Si wafer is used as the substrate. The base plating layer is formed (S12) after surface activation (S11), and the soft magnetic film is formed thereon by plating (S13).

In the first heat treatment (S14), the soft magnetic plating film before polishing (S15) has a relatively large thickness and contains a number of liquid components and gaseous components. Therefore, it is important to perform the first heat treatment under relatively mild conditions such that the elimination of these components causes no structural defects in the film. For this reason, the temperature of the first heat treatment is preferably set lower than that of the second heat treatment (S16). For example, when the temperature of the first heat treatment is 100° C. to 250° C., most of liquid components and gaseous components can be eliminated and the strength of the plating film can be increased. It is thus possible to reduce exfoliation in the polishing of the plating film after the heat treatment. The temperature of the second heat treatment is higher than that of the first heat treatment step by 30° C. or more, so that processing damage can be more effectively reduced. For example, it is preferable to set the temperature of the second heat treatment at 150° C. to 300° C.

The heat treatment process divided into two or more steps enables mild treatment conditions for the heat treatment steps, offering the following benefits: damage on the soft magnetic film can be reduced, a structural defect caused by the elimination of components is hard to occur, and processing damage occurring in the film due to polishing can be reduced by the heat treatment after polishing.

When performing at least one of the first and second heat treatment while a magnetic field is applied, the soft magnetic film can have magnetic anisotropy or can be made magnetically isotropic by combination with the conditions of the revolution and rotation of the substrate in the plating deposition step.

In view of the elimination of undesirable components, the atmosphere of the heat treatment step may be cleaned air. However, when performing the heat treatment in an atmosphere of air, oxygen in the atmosphere may form an oxide film on the surface of the soft magnetic film. Therefore, when avoiding the formation of such an oxide film, it is preferable to perform the heat treatment in an atmosphere of inert gas (for example, an atmosphere of Ar gas). The heat treatment can be also performed in a vacuum. However, in the case of the heat treatment in a vacuum, it should be noted that a rapid increase in the number of components to be eliminated may cause a structural defect in the film. To be specific, it is necessary to have a low ramping speed during a temperature rise to reduce the occurrence of defects.

(Magnetic recording layer 13): The magnetic recording layer 13 provided on the soft magnetic backing layer 12 is made of a hard magnetic material for performing perpendicular magnetic recording. Although the magnetic recording layer 13 may be directly formed on the soft magnetic backing layer 12, various intermediate films may be provided as necessary for matching between the crystal grain size and the magnetic properties and the magnetic recording layer 13 may be formed on the intermediate films. The intermediate film is, for example, a Ru film. Further, two or more layers of intermediate film may be stacked.

The composition of the magnetic recording layer 13 is not particularly limited as long as the magnetic recording layer 13 is made of a hard magnetic material which can form magnetic domains easily magnetized perpendicularly to a layer surface. When the magnetic recording layer 13 is formed by the sputtering method, for example, a Co—Cr alloy film, an Fe—Pt alloy film, a CoCr—Si granular film, a Co/Pd multilayer film, and soon can be used. When the magnetic recording layer 13 is formed by a wet process, for example, a Co—Ni plating film, a coating film made of barium ferrite having a magnetoplumbite phase, and so on can be used.

The magnetic recording layer 13 is preferably about 5 nm to 100 nm in thickness and more preferably about 10 nm to 50 nm in thickness. Further, the magnetic recording layer 13 is formed such that the coercive force is preferably 0.5 to 10 kilooersteds (kOe) and more preferably 3 to 6 kilooersteds (kOe).

(Protective layer 14 and lubricating layer 15): The protective layer 14 on the top surface of the magnetic recording layer 13 can be formed of materials having been used in conventional magnetic recording media. For example, it is possible to use an amorphous carbon protective film formed by the sputtering method or CVD method and a crystalline protective film made of a material such as alumina (Al₂O₃). The lubricating layer 15 provided on the top surface of the protective layer 14 can be also formed by applying materials having been used in conventional magnetic recording media. The kinds of material and the applying method are not particularly limited. For example, the lubricating layer 15 is formed by applying fluorine oil and forming a monomolecular film and so on. The protective layer 14 and the lubricating layer 15 are, for example, about 2 nm to 20 nm in thickness.

The present invention will be more specifically described below in accordance with the following embodiment. The present invention is not limited to this example.

### Embodiment

In the present embodiment, a single-crystal Si substrate was used as a non-magnetic substrate. Coring, centering, and lapping were performed to obtain a Si single crystal plate (100) having a diameter of 65 mm (n-type doped with P) from a Si single crystal which had a diameter of 200 mm (8 inches) and had been obtained by crystal breeding according to CZ method. Both sides of the Si single crystal plate were polished with slurry containing colloidal silica having an average grain size of 15 nm, and a Si substrate was obtained with a surface roughness (Rms) of 4 nm. Rms represents a root mean square roughness (root-mean-square surface roughness) which was measured using an AFM (atomic force microscope).

The Si substrate was dipped into a caustic soda solution of 2 mass % (the liquid temperature was 45° C.) for three minutes to remove a thin surface oxide film on the substrate, surface activation was performed to etch Si on the surface of a pole, and then the substrate was dipped for five minutes into a bath which is a base plating bath having been prepared by adding ammonium sulfate of 0.5 N to a nicotine sulfate solution of 0.1 N and keeping the bath at 80° C., so that a base Ni plating layer was obtained.

Next, a plating solution containing ammonium sulfate of 0.2 N, nickel sulfate of 0.02 N, cobalt sulfate of 0.1 N, iron sulfate of 0.01 N, and dimethylamine borane of 0.04 N as a reducing agent was prepared and the solution was heated and kept at 65° C. The temperature of the solution was kept at 65° C. to have a film deposition rate of 0.1 μm/min during electroless plating on a soft magnetic backing layer.

FIG. 5 is a conceptual rendering for explaining a state of plating deposition of a soft magnetic film through the plating bath. A tank 17 in which a plating bath 18 had been stored was placed between a north pole 19a and a south pole 19b of a permanent magnet magnetic circuit such that magnetic lines of force 20 generated from a magnet pass though the plating bath 18. A Si substrate 10 having a base plating layer formed thereon was dipped into the plating bath 18, and external magnetic fields of 450 to 600 oersteds (Oes) were applied so as to substantially form a right angle between a surface of the Si substrate 10 and the magnetic lines of force 20.

In this magnetic field application environment, electroless plating was performed for 20 minutes while causing the Si substrate 10 to rotate on its axis at 60 rpm, so that a soft magnetic film was obtained which was predominantly composed of Ni—Co—Fe and contained S, C and B with a thickness of 1200 nm on the base plating layer.

In the soft magnetic film obtained thus, the easy axis of magnetization was the in-plane radial direction and anisotropy was obtained with a difference (δH=H_{d}−H_{c}) of about 20 oersteds between magnetization saturation magnetic field strength (H_{d}) in the in-plane radial direction and magnetization saturation magnetic field strength (H_{c}) in the in-plane circumferential direction. Further, the coercive force was substantially 5 oersteds (Oe) or less, which was an excellent soft magnetic property.

The Si substrate having the soft magnetic film was subjected to a first heat treatment at three temperatures of 120° C., 150° C., and 200° C. for one hour in an atmosphere of Ar gas, so that liquid components and gaseous components in the film were eliminated. Next, polishing was performed using slurry containing suspended colloidal silica to adjust the thickness of the soft magnetic film to about 600 nm, and the soft magnetic film was used as a soft magnetic backing layer. The root-mean-square surface roughness (Rms) was 0.4 nm after the polishing. The soft magnetic backing layer was subjected to a second heat treatment at three temperatures of 200° C., 250° C., and 300° C. for one hour while a magnetic field of 500 Oe was applied in the circumferential direction and a magnetic field of 1 kOe was applied in the radial direction to respective samples in an atmosphere of Ar gas, so that remaining liquid components and gaseous components were further eliminated.

Tables 1A and 1B show coercive forces (Hc) before the first heat treatment (after plating deposition) and after the second heat treatment and surface defect inspection results after the second heat treatment. In any conditions, excellent soft magnetic properties were obtained and no defect was found after the heat treatment. After the second heat treatment (in a magnetic field), an anisotropic orientation and Hc vary with the direction of the magnetic field application of the heat treatment in a magnetic field. Nearly constant and satisfactory values were obtained as Hc.

TABLE 1A

| HEAT | | | |
|---|---|---|---|
| TREATMENT | | | |
| TEMPERATURE | 1^{st}: 120° C./ | 1^{st}: 150° C./ | 1^{st}: 200° C./ |
| CONDITIONS | 2^{nd}: 200° C. | 2^{nd}: 250° C. | 2^{nd}: 250° C. |
| Hc | 4.5 | 4.8 | 3.8 |
| (BEFORE FIRST | | | |
| HEAT | | | |
| TREATMENT: Oe) | | | |
| Hc | 4.3 | 4.4 | 4.5 |
| (AFTER SECOND | | | |
| HEAT | | | |
| TREATMENT: Oe) | | | |
| DEFECT (AFTER | FINE | FINE | FINE |
| SECOND HEAT | | | |
| TREATMENT) | | | |

TABLE 1B

| HEAT TREATMENT | | | |
|---|---|---|---|
| TEMPERATURE | | | |
| CONDITIONS AND | | | |
| ANISOTROPIC | 1^{st}: 150° C./ | 1^{st}: 180° C./ | 1^{st}: 200° C./ |
| ORIENTATION | 2^{nd}: 200° C. | 2^{nd}: 250° C. | 2^{nd}: 300° C. |
| Hc/ | 4.4 | 4.5 | 3.9 |
| CIRCUMFERENTIAL | | | |
| (BEFORE FIRST HEAT | | | |
| TREATMENT: Oe) | | | |
| Hc/RADIAL | 4.0 | 3.7 | 4.6 |
| (AFTER SECOND | | | |
| HEAT | | | |
| TREATMENT: Oe) | | | |
| DEFECT (AFTER | FINE | FINE | FINE |
| SECOND HEAT | | | |
| TREATMENT) | | | |

Each Si substrate was kept at 200° C. after the two-stage heat treatment and the gas generation level of the soft magnetic backing layer was inspected by a GC-MASS spectrometer. As a result, generated gas was hardly detected from each substrate. Therefore, it was understood that most of liquid components and gaseous components which had been taken in the soft magnetic film were eliminated from the film under the two-stage heat treatment conditions.

A perpendicular magnetic recording layer was formed by sputtering on the soft magnetic backing layer. The magnetic recording layer was obtained under the following sputtering conditions: a magnetic film having a thickness of 15 nm with a composition of Co:Cr:Pt=76:19:5 (mass %) was formed in a state in which the substrate temperature was kept at 180° C. The magnetic recording layer had a coercive force of 4.5 kilooersteds (kOe) perpendicularly to a film surface and a coercive force of 500 oersteds (Oe) in parallel with the film surface.

The magnetic recording layer was coated with amorphous carbon having a thickness of 10 nm, and then a fluorine lubricating film was applied thereon by a dipping method, so that the perpendicular magnetic recording medium was obtained.

After the perpendicular magnetic recording medium was set on a spin stand and DC erased, writing was performed by a nano-slider head having a flying height of 10 nm and the noise level of a playback signal was measured. As a result, no spike noise was found in an envelope pattern. The average level of the S/N ratio was 21 dB, which was a preferable level.

### COMPARATIVE EXAMPLE

A soft magnetic backing layer was obtained under the same conditions as the example except for the first and second heat treatment temperatures. Coercive forces (Hc) of the film before a first heat treatment (after plating deposition) and after a second heat treatment and the level of a surface defect after the second heat treatment were examined.

Table 2 shows the results. Two heat treatment conditions were set as follows: the first heat treatment at 90° C. and the second heat treatment at 90° C. (the temperatures were both lower than 100° C.), and the first heat treatment at 360° C. and the second heat treatment at 380° C. (the temperatures were both higher than 350° C.). In the second heat treatment, a magnetic field was 500 Oe in the circumferential direction.

TABLE 2

| HEAT TREATMENT | | |
|---|---|---|
| TEMPERATURE | 1^{st}: 90° C./ | 1^{st}: 360° C./ |
| CONDITIONS | 2^{nd}: 90° C. | 2^{nd}: 380° C. |
| Hc (BEFORE FIRST | 4.5 | 4.8 |
| HEAT | | |
| TREATMENT: Oe)/ | | |
| CIRCUMFERENTIAL | | |
| Hc (AFTER SECOND | 4.5 | 11.5 |
| HEAT | | |
| TREATMENT: Oe)/ | | |
| CIRCUMFERENTIAL | | |
| DEFECT (AFTER | FINE | DEFECTS |
| SECOND HEAT | | INCREASE |
| TREATMENT) | | |

In the case of the first heat treatment at 90° C. and the second heat treatment at 90° C., the soft magnetic property (coercive force Hc) and the surface defect level of the soft magnetic backing layer were preferable. However, when the film was kept at 200° C. and generated gas was inspected by a GC-MASS spectrometer, mainly the generation of water and hydrogen gas was clearly observed. Further, in a state in which a magnetic recording layer was formed on the soft magnetic backing layer to obtain the perpendicular magnetic recording medium, severe surface roughness occurred and interfered with the floating of a magnetic head. It is considered that this is because a substrate was heated to about 200° C. in a vacuum during the formation of the magnetic recording layer and thus components remaining in the soft magnetic backing layer were rapidly eliminated in this process.

In the case of the first heat treatment at 360° C. and the second heat treatment at 380° C., an increase in the coercive force Hc was observed after the second heat treatment and the number of surface defects increased in the soft magnetic backing layer. It is considered that because of the high heat treatment temperature over 350° C., liquid components and gaseous components having been taken in the soft magnetic film were rapidly eliminated during the heat treatment, so that the surface defects increased. Further, in a perpendicular magnetic recording medium including a magnetic recording layer formed on the soft magnetic backing layer, severe surface roughness occurred, only a few tracks allowed a magnetic head to float, and the characteristics of the magnetic recording medium could not be measured.

As described above, the present invention provides a substrate suitable for fabricating a perpendicular magnetic recording medium having an excellent signal reproduction property with low noise, and a fabrication method thereof.

1. A substrate for a magnetic recording medium, comprising:
a non-magnetic substrate shaped like a disk having a diameter of 90 mm or less, and
a soft magnetic backing layer provided on a major surface of the substrate,
wherein the soft magnetic backing layer is a plating layer containing at least two elements selected from the group consisting of Co, Ni, and Fe and at least one element selected from the group consisting of B, C, P and S, and
the plating layer has at least two histories of heat treatment after plating deposition.

2. The substrate for a magnetic recording medium according to claim 1, wherein the plating layer is 150 nm to 1000 nm in thickness and a temperature of the heat treatment is 100° C. to 350° C.

3. The substrate for a magnetic recording medium according to claim 1, wherein the non-magnetic substrate is a silicon wafer and comprises a base plating layer made of Ni or NiP between the major surface of the substrate and the plating layer.

4. The substrate for a magnetic recording medium according to claim 3, wherein the base plating layer is 10 nm to 1000 nm in thickness.

5. The substrate for a magnetic recording medium according to claim 1, wherein the soft magnetic backing layer has a surface roughness expressed by an Ra value of 0.4 nm or less.

6. A method of fabricating a substrate for a magnetic recording medium, comprising:
an electroless plating step of forming a soft magnetic backing layer on a major surface of a non-magnetic substrate shaped like a disk having a diameter of 90 mm or less, and
a heat treatment step after the electroless plating step,
wherein in the electroless plating step, plating deposition of the soft magnetic backing layer is performed by dipping the substrate into a plating bath containing at least two metal ions selected from the group consisting of Co, Ni, and Fe and at least one element selected from the group consisting of B, C, P and S, and
the heat treatment step is performed at 100° C. to 350° C.

7. The method of fabricating the substrate for a magnetic recording medium according to claim 6, wherein the heat treatment step is performed at 150° C. to 300° C.

8. The method of fabricating the substrate for a magnetic recording medium according to claim 6, further comprising a polishing step after the plating deposition of the soft magnetic backing layer,
wherein the heat treatment step includes a first heat treatment step performed before the polishing step and a second heat treatment step performed after the polishing step.

9. The method of fabricating the substrate for a magnetic recording medium according to claim 8, wherein a treatment temperature of the second heat treatment step is higher than a treatment temperature of the first heat treatment step by 30° C. or more.

10. The method of fabricating the substrate for a magnetic recording medium according to claim 8, wherein at least one of the first and second heat treatment steps is performed while a magnetic field of 100 Oe to 5 kOe is applied.

11. The method of fabricating the substrate for a magnetic recording medium according to claim 6, wherein the heat treatment step is performed in an atmosphere of cleaned air or inert gas or in a vacuum.

12. The method of fabricating the substrate for a magnetic recording medium according to claim 6, wherein a silicon wafer is selected as the substrate, and
the method further comprises, before the electroless plating step, a step of forming a base plating layer made of Ni or NiP by dipping the silicon wafer into a plating bath containing a Ni ion or a plating bath obtained by adding a phosphorus reducing agent to a bath containing a Ni ion.

13. The method of fabricating the substrate for a magnetic recording medium according to claim 12, further comprising, before the step of forming the base plating layer, a substrate surface processing step of removing an oxide film on a surface of the silicon wafer.

14. A magnetic recording medium, comprising:
a non-magnetic substrate shaped like a disk having a diameter of 90 mm or less,
a soft magnetic backing layer provided on a major surface of the substrate, and
a magnetic recording layer provided on the soft magnetic backing layer,
wherein the soft magnetic backing layer is a plating layer containing at least two elements selected from the group consisting of Co, Ni, and Fe and at least one element selected from the group consisting of B, C, P and S, and
the plating layer has at least two histories of heat treatment after plating deposition.

15. The magnetic recording medium according to claim 14, wherein the plating layer is 150 nm to 1000 nm in thickness and a temperature of the heat treatment is 100° C. to 350° C.

16. The magnetic recording medium according to claim 14, wherein the non-magnetic substrate is a silicon wafer and comprises a base plating layer made of Ni or NiP between the major surface of the substrate and the plating layer.

17. The magnetic recording medium according to claim 14, wherein the base plating layer is 10 nm to 1000 nm in thickness.

18. The magnetic recording medium according to claim 14, wherein the soft magnetic backing layer has a surface roughness expressed by an Ra value of 0.4 nm or less.
